(19) United States
(12) Patent Application Publication
(10) Pub. No.: US 2018/0082801 A1
(43) Pub. Date: Mar. 22, 2018

(54) TRANSLUCENT KEYCAP AND METHOD OF FABRICATING THE SAME

(71) Applicant: DARFON ELECTRONICS CORP., Taoyuan City (TW)

(72) Inventors: Kuang-Chen LIN, TAOYUAN CITY (TW); Tsai-Jung HU, TAOYUAN CITY (TW)

(21) Appl. No.: 15/708,698

(22) Filed: Sep. 19, 2017

(30) Foreign Application Priority Data
Sep. 19, 2016 (TW) 105130201
Aug. 31, 2017 (TW) 106129741

(51) Int. Cl. H01H 13/02; H01H 13/14; H01H 11/00

(52) U.S. Cl. CPC H01H 13/023; H01H 13/14; H01H 11/00; H01H 2229/006; H01H 2219/054; H01H 2221/07; H01H 2229/002; H01H 2233/07

(57) ABSTRACT

The invention discloses a translucent keycap and a method of fabricating the same. The translucent keycap according to the invention includes a translucent base, a first colored translucent layer, a light-shielding layer and a second colored translucent layer. The first colored translucent layer overlays an outer surface of the translucent base. The light-shielding layer overlays the first colored translucent layer, and has a hollowed region. The hollowed region penetrates the light-shielding layer such that a portion of the first colored translucent layer is exposed within the hollowed region. The second colored translucent layer covers the hollowed region. When a light travels upward from beneath the translucent keycap, the light is capable of passing through the translucent base, the first colored translucent layer, the hollowed region and the second colored translucent layer such that the hollowed region emits a color light.

### CROSS-REFERENCE TO RELATED APPLICATION

This utility application claims priorities to Taiwan Application Serial Number 105130201, filed Sep. 19, 2016, and Taiwan Application Serial Number 106129741, filed Aug. 31, 2017, which are incorporated herein by reference.

### BACKGROUND OF THE INVENTION

### 1. Field of the Invention

The invention relates to a translucent keycap and a method of fabricating the same, and in particular, to a translucent keycap capable of benefiting in previously manufacturing of a semi-finished product of such translucent keycap and a method fabricating the same.

### 2. Description of the Prior Art

As for a prior art of a translucent keycap, please refer to Taiwan Patent issued No. 1494962. Please refer to FIG. 1, FIG. 1 is a cross sectional view illustratively showing the structure of the translucent keycap 1 disclosed in Taiwan Patent issued No. 1494962.

As shown in FIG. 1, the translucent keycap 1 includes a translucent base 10, a first colored translucent layer 12, a first dark color layer 14, a second colored translucent layer 16 and a second dark color layer 18.

The first colored translucent layer 12 is coated on an outer surface 102 of the translucent base 10. The first colored translucent layer 12 covers a first patterned region, and does not cover a second patterned region. The first patterned region and the second patterned region respectively represent different characters. The first dark color layer 14 is coated on the first colored translucent layer 12. The second colored translucent layer 16 is coated on the translucent base 10 and the first dark color layer 14. The second dark color layer 18 is coated on the second colored translucent layer 16. The color of the first colored translucent layer 12 is different from that of the second colored translucent layer 16. The second dark layer 18 has a first hollowed region 182 and a second hollowed region 184. The first hollowed region 182 penetrates the second dark color layer 18, the second colored translucent layer 16 and the first dark color layer 14 corresponding to the first patterned region. The second hollowed region 184 penetrates the second dark color layer 18 corresponding to the second patterned region.

When a light OL travels upward from beneath the translucent keycap 1, the light OL is capable of passing through the first colored translucent layer 12 and the first hollowed region 182 such that the first hollowed region 182 emits a first color light L1. The light OL is also capable of passing through the second colored translucent layer 16 and the second hollowed region 184 such that the second hollowed region 184 emits a second color light L2. Thereby, different characters on the translucent keycap 1 emit different color lights. In this way, the first colored translucent layer 12 and the second colored translucent layer 16 both locate beneath the second dark color layer 18. By use of different hollowed regions on the second dark color layer 18 corresponding to different colored translucent layers, the character regions emitting different color lights are defined.

As for another prior art of a translucent keycap, please refer to China Patent Publication No. 102420065A. China Patent Publication No. 102420065A discloses that a first colored translucent layer is previously coated on a translucent base, a second colored translucent layer is then printed on the first colored translucent layer, and finally a topcoat layer is coated to finish the translucent keycap. That is to say, the first colored translucent layer and the second colored translucent layer both locate beneath the topcoat layer. By use of different hollowed regions on the topcoat layer corresponding to different colored translucent layers, the character regions emitting different color lights are defined

However, the color lights emitted by the translucent keycaps of aforesaid prior arts depend on two colored translucent layers beneath the topcoat layer (or the second dark color layer 18). Once coating procedure of the topcoat layer (or the second dark color layer 18 is finished, two color lights emitted by the translucent keycaps of aforesaid prior arts cannot be changed by post process. If the customer's order requires changing the color lights emitted by the translucent keycap fabricated according to the aforesaid prior arts, the semi-finished product of the translucent keycap been coated with the topcoat can only be discarded.

Therefore, the manufacture of the translucent keycaps according to the prior arts cannot previously prepare a large number of semi-finished products been coated with the topcoat layers, and cannot, then in order to shorten the delivery time, dynamically adjust the follow-up process to produce finished products in accordance with luminous color specified by the customer's order. Obviously, the manufacture of the translucent keycaps according to the prior arts lacks of flexibility and convenience.

### SUMMARY OF THE INVENTION

Accordingly, one scope of the invention is to provide a translucent keycap capable of benefiting in previously manufacture of a semi-finished product of such translucent keycap and a method fabricating the same.

A translucent keycap according to a first preferred embodiment of the invention includes a translucent base, a first colored translucent layer, a light-shielding layer and a second colored translucent layer. The translucent base has an outer surface. The first colored translucent layer overlays the outer surface of the translucent base. The light-shielding layer overlays the first colored translucent layer, and has a light-shielding region and a first hollowed region. The first hollowed region penetrates the light-shielding layer such that a first portion of the first colored translucent layer is exposed within the first hollowed region. The second colored translucent layer is formed to cover the first hollowed region. The light-shielding layer also has a peripheral region surrounding the first hollowed region. The second colored translucent layer also extends onto the light-shielding layer and covers the peripheral region. When a light travels upward from beneath the translucent keycap, the light is capable of passing through the translucent base, the first colored translucent layer, the first hollowed region and the second colored translucent layer such that the first hollowed region emits a first color light. The light-shielding layer blocks the light from passing so that the first hollowed region is brighter than a light-shielded region of the translucent keycap overlaid by the light-shielding layer.

Further, the light-shielding layer of the translucent keycap according to the first preferred embodiment of the invention also has a second hollowed region. The second hollowed region penetrates the light-shielding layer such that a second portion of the first colored translucent layer is exposed within the second hollowed region. When the light travels upward from beneath the translucent keycap, the light is also capable of passing through the translucent base, the first colored translucent layer and the second hollowed region such that such that the second hollowed region emits a second color light different from the first color light.

Further, the translucent keycap according to the first preferred embodiment of the invention also includes a transparent protection layer. The transparent protection layer overlays the light-shielding layer, the second colored translucent layer and the second hollowed region. The hardness of the transparent protection layer is higher than that of the light-shielding layer.

A translucent keycap according to a preferred embodiment of the invention includes a translucent base, a first colored translucent layer, a light-shielding layer and a second colored translucent layer. The translucent base has an outer surface. The first colored translucent layer overlays the outer surface of the translucent base. The light-shielding layer overlays the first colored translucent layer, and has a light-shielding region and a first hollowed region. The first hollowed region penetrates the light-shielding layer such that a first portion of the first colored translucent layer is exposed within the first hollowed region. The second colored translucent layer is formed to cover the first hollowed region. Alternatively, a gap exist between the second colored translucent layer and an edge of the hollowed region.

A method of fabricating a translucent keycap according to a preferred embodiment of the invention, firstly, is to prepare a translucent base where the translucent base has an outer surface. Next, the method of the invention is to form a first colored translucent layer to overlay the outer surface of the translucent base. Then, the method of the invention is to form a light-shielding layer formed to overlay the first colored translucent layer. Subsequently, the method of the invention is to form a first hollowed region on the light-shielding layer where the first hollowed region penetrates the light-shielding layer such that a first portion of the first colored translucent layer is exposed within the first hollowed region. Finally, the method of the invention is to form a second colored translucent layer to cover the first hollowed region.

In one embodiment, formation of the first colored translucent layer and the light-shielding layer is performed by the steps of: integrating the first colored translucent layer and the light-shielding layer into a covering film; covering the covering film on the outer surface of the translucent base, where the covering film includes, in sequence adjacent the outer surface of the translucent base, the first colored translucent layer, the light-shielding layer, a release layer and a base layer; attaching the covering film on the outer surface of the translucent base; and tearing off the base layer and the release layer to remain the first colored translucent layer and the light-shielding layer bonded on the outer surface of the translucent base.

Distinguishable from the prior arts, the second colored translucent layer of the translucent keycap of the invention is formed on the light-shielding layer. The manufacturing process of the translucent keycaps according to the invention is relatively simple. Moreover, the manufacturing of the translucent keycap according to the invention has flexibility and convenience.

The advantage and spirit of the invention may be understood by the following recitations together with the appended drawings.

### BRIEF DESCRIPTION OF THE APPENDED DRAWINGS

FIG. 1 is a cross sectional view of a translucent keycap of a prior art.

FIG. 2 is a perspective view of a translucent keycap according to a first preferred embodiment of the invention.

FIG. 3 is another perspective view of the translucent keycap according to the first preferred embodiment of the invention.

FIG. 4 is a cross sectional view of the translucent keycap taken along the A-A line of FIG. 3.

FIG. 5 is a cross sectional view of a modification of the translucent keycap according to the first preferred embodiment of the invention.

FIG. 6 is another cross sectional view of the modification of the translucent keycap according to the first preferred embodiment of the invention.

FIG. 7 is a cross sectional view of the translucent keycap taken along the B-B line of FIG. 6.

FIG. 8 is a perspective view of a translucent keycap according to a second preferred embodiment of the invention.

FIG. 9 is another perspective view of a translucent keycap according to the second preferred embodiment of the invention.

FIG. 10 is a cross sectional view of the translucent keycap taken along the C-C line of FIG. 9.

FIG. 11 is a cross sectional view of a modification of the translucent keycap according to the second preferred embodiment of the invention.

FIG. 12 is another cross sectional view of a modification of the translucent keycap according to the second preferred embodiment of the invention.

FIG. 13 is a cross sectional view of the translucent keycap taken along the D-D line of FIG. 12.

FIGS. 14 through 21 are cross sectional views schematically illustrate the method according to the preferred embodiment of the invention to fabricate the translucent keycap.

FIG. 22 is a local cross sectional view of a covering film previously integrating the first colored translucent layer and the light-shielding layer of the translucent keycap of the invention.

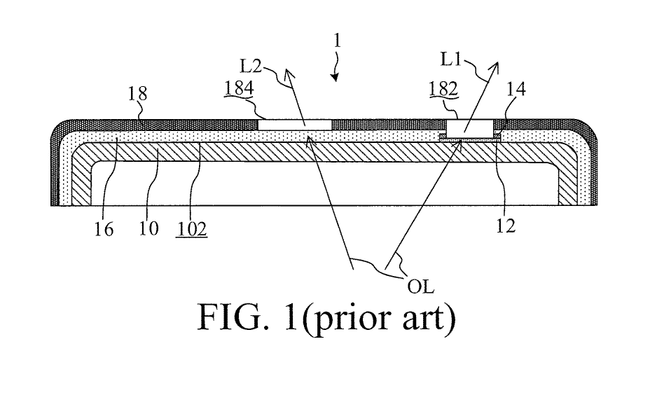

### DETAILED DESCRIPTION OF THE INVENTION

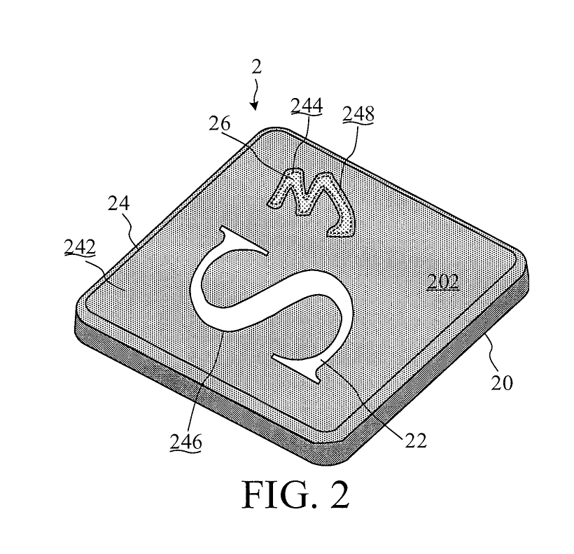

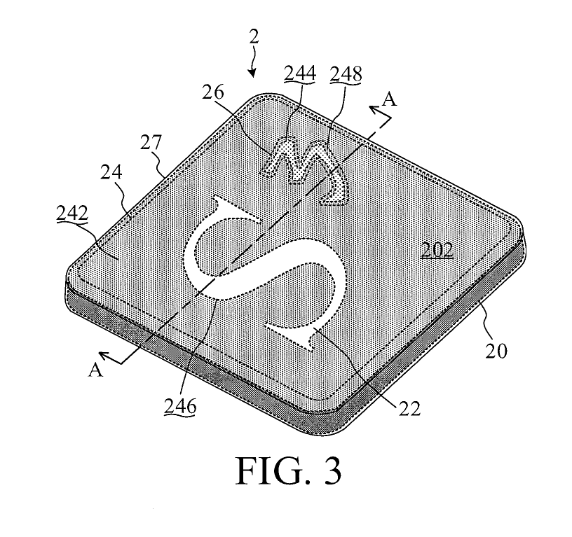

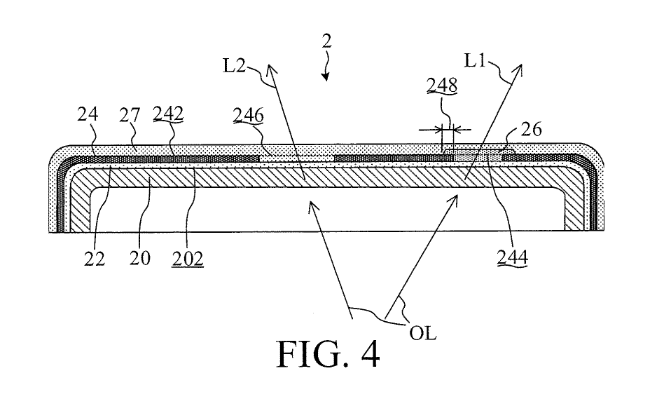

Referring to FIGS. 2 to 4, those drawings schematically illustrate a translucent keycap 2 according to a first preferred embodiment of the invention. FIGS. 2 and 3 both schematically illustrate with perspective views the translucent keycap 2 according to the first preferred embodiment of the invention. FIG. 4 is a cross sectional view of the translucent keycap 2 taken along the A-A line of FIG. 3. The translucent keycap 2 according to the first preferred embodiment is suitable to be assembled in a keyswitch of an illuminated keyboard.

As shown in FIGS. 2 to 4, the translucent keycap 2 according to the first preferred embodiment of the invention includes a translucent base 20, a first colored translucent layer 22, a light-shielding layer 24 and a second colored translucent layer 26. The translucent base 20 has an outer surface 202. The first colored translucent layer 22 overlays the outer surface 202 of the translucent base 20. The light-shielding layer 24 overlays the first colored translucent layer 22.

In one embodiment, the first colored translucent layer 22 can be, but not limited to, a light color ink layer, for example, a white ink layer. The light-shielding layer 24 can be, but not limited to, a dark color ink layer, for example, a black ink layer.

The light-shielding layer 24 has a light-shielding region 242 and a first hollowed region 244. The first hollowed region 244 penetrates the light-shielding layer 24 such that a first portion of the first colored translucent layer 22 is exposed within the first hollowed region 244. The second colored translucent layer 26 is formed to cover the first hollowed region 244. It is emphasized that the function of the second dark color layer 18 of the translucent keycap 1 of the prior art is the same as that of the light-shielding layer 24 of the translucent key cap 2 of the invention. But, the second dark color layer 18 of the translucent keycap 1 of the prior art is coated on the first colored translucent layer 12 and the second colored translucent layer 16.

In one embodiment, the second colored translucent layer 26 can be an ink layer having a color depth between the first colored translucent layer 22 and the light-shielding layer 24, for example, a light blue ink layer.

When a light OL travels upward from beneath the translucent keycap 2, the light is capable of passing through the translucent base 20, the first colored translucent layer 22, the first hollowed region 244 and the second colored translucent layer 26 such that the first hollowed region 244 emits a first color light L1. The light-shielding layer 24 blocks the light OL from passing so that the first hollowed region 244 is brighter than the light-shielded region 242 overlaying the translucent keycap 2. In practical application, the first hollowed region 244 corresponds to a first pattern. The first pattern represents one of the characters, numbers, symbols and function keys.

Further, also shown in FIGS. 2 to 4, the light-shielding layer 24 of the translucent keycap 2 according to the first preferred embodiment of the invention also has a second hollowed region 246. The second hollowed region 246 penetrates the light-shielding layer 24 such that a second portion of the first colored translucent layer 22 is exposed within the second hollowed region 246. When the light OL travels upward from beneath the translucent keycap 2, the light OL is also capable of passing through the translucent base 20, the first colored translucent layer 22 and the second hollowed region 246 such that the second hollowed region 246 emits a second color light L2 different from the first color light L1. The second hollowed region 246 is brighter than the light-shielded region 242. In practical application, the second hollowed region 246 corresponds to a second pattern. The second pattern represents one of the characters, numbers, symbols and function keys, but is different from the first pattern.

Further, as shown in FIGS. 3 and 4, the translucent keycap 2 according to the first preferred embodiment of the invention also includes a transparent protection layer 27. The transparent protection layer 27 is formed to overlay the light-shielding layer 24, the second colored translucent layer 26 and the second hollowed region 246. The hardness of the transparent protection layer 27 is higher than that of the light-shielding layer 24 to protect the light-shielding layer 24 from being abrading. By the selection of the molding material, the transparent protection layer 27 may also have an anti-ultraviolet function to prevent the translucent base 20 from being damaged by ultraviolet rays.

It is considered that the second color light transmitting layer 26 may have a positional shift error with respect to the light-shielding layer 24 during the manufacture of the translucent keycap 2. Therefore, so that the second colored translucent layer 26 preferably has the same outline profile as the first hollowed region 244, but has dimensions slightly larger than that of the first hollowed region 244. This way can reduce the probability that the first hollowed region 244 not being completely covered by the second colored translucent layer 26 due to the position shift error results in flaws of partially emitting different color light.

In one embodiment, as shown in FIGS. 2 to 4, the light-shielding layer 24 has a peripheral region 248 surrounding the first hollowed region 244. The second colored translucent layer 26 completely covers the first hollowed region 244, also extends onto the peripheral region 248. By the selection of color of the ink of forming the second colored translucent layer 26, the reflectivity of the second colored translucent layer 26 relative to an ambient light illuminating from above can be reduced. Thereby, a visual difference between the peripheral region 248 covered by the second colored translucent layer 26 and the light-shielding layer 24 other than the peripheral region 248 cannot be recognized by users' eyes. That is to say that without the light OL emitting from beneath and with only the ambient light illuminating from above, the users will still observe only that the first hollowed region 244 is brighter and the peripheral region 248 and the other region of the light-shielding layer 24 are dark, so that the peripheral edge represented by the first hollow region 244 can be clearly seen.

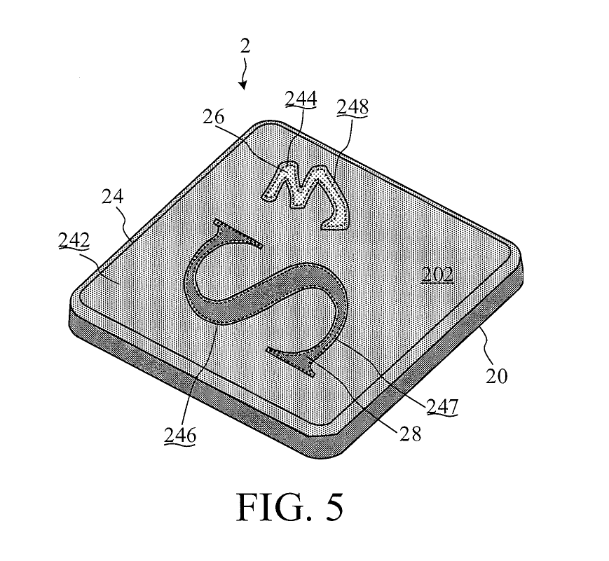

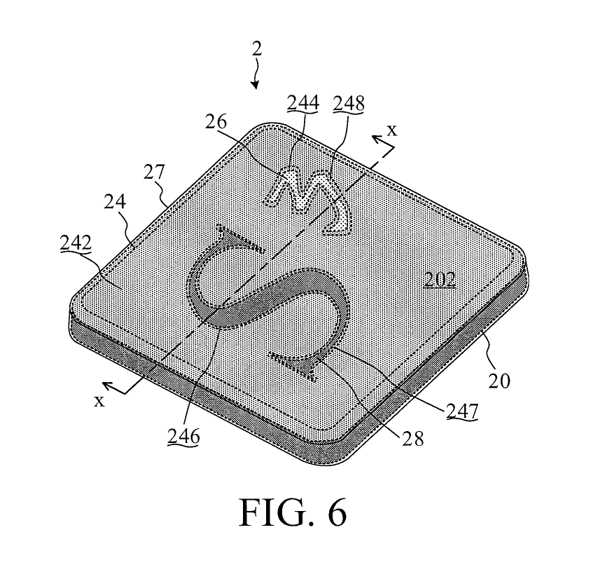

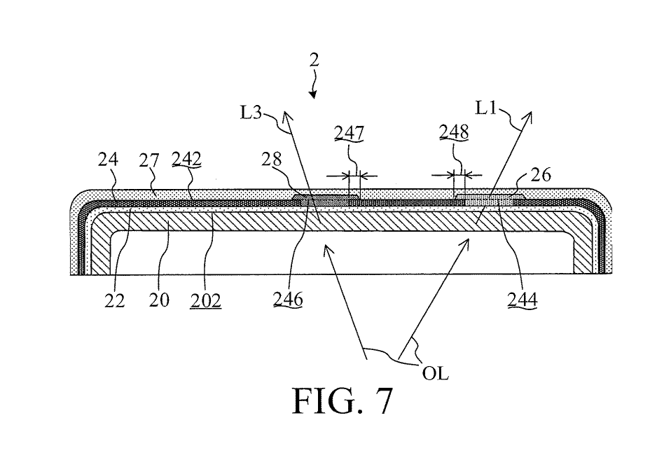

Referring to FIGS. 5 to 7, FIGS. 5 and 6 are respectively a cross sectional view of a modification of the translucent keycap 2 according to the first preferred embodiment of the invention. FIG. 7 is a cross sectional view of the translucent keycap 2 taken along the B-B line of FIG. 6. As shown in FIGS. 5 and 6, further, the translucent keycap 2 according to the first preferred embodiment of the invention also includes a third colored translucent layer 28. The third colored translucent layer 28 is formed to cover the second hollowed region 246. The third colored translucent layer 28 is different from the second colored translucent layer 26. The light OL is capable of passing through the translucent base 20, the first colored translucent layer 22, the second hollowed region 246 and the third colored translucent layer 28 such that the second hollowed region 246 emits a third color light L3 different from the first color light L1. The components and devices in FIGS. 5 to 7 identical to those shown in FIGS. 2 to 4 are given the same numerical notations, and will be not described in detail herein.

In one embodiment, the third colored translucent layer 28 can be an ink layer having a color depth between the first colored translucent layer 22 and the light-shielding layer 24, for example, a light orange ink layer.

In the examples shown in FIGS. 5 to 7, the light-shielding layer 24 also has a peripheral region 247 surrounding the second hollowed region 246. The third colored translucent layer 28 completely covers the second hollowed region 246, also extends onto the peripheral region 247. The translucent keycap 2 shown in FIGS. 6 and 7 also includes a transparent protection layer 27. The transparent protection layer 27 is formed to overlay the light-shielding layer 24, the second colored translucent layer 26 and the third colored translucent layer 28.

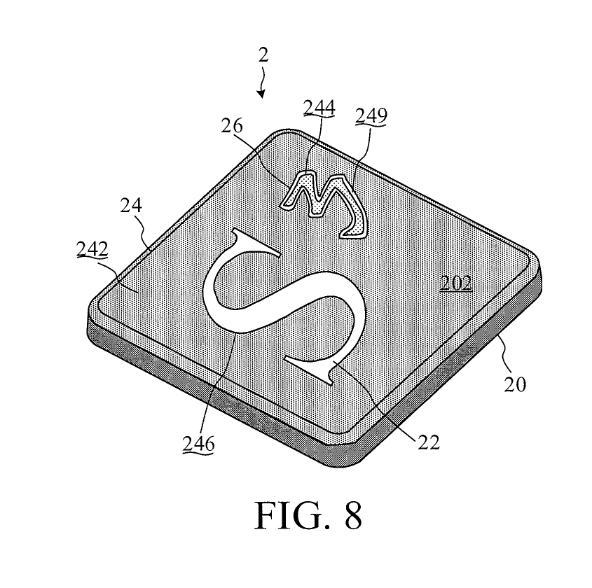

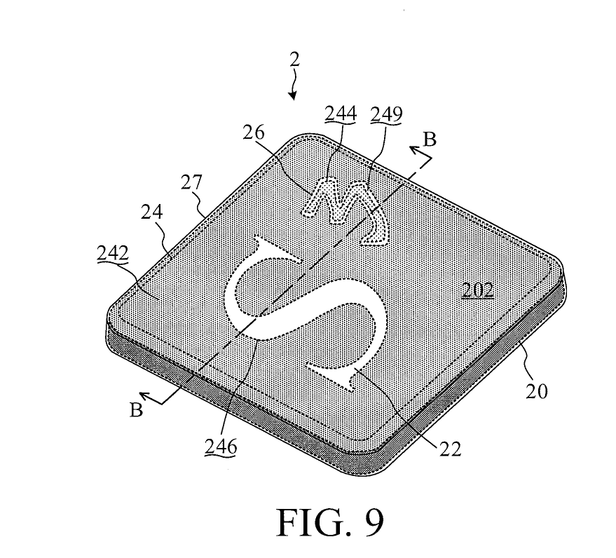

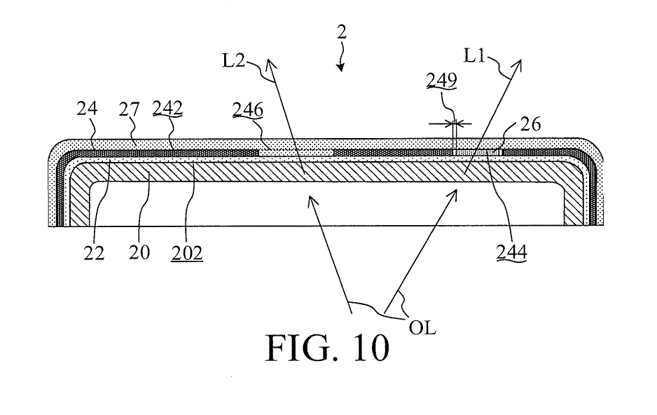

Referring to FIGS. 8 to 10, those drawings schematically illustrate a translucent keycap 2 according to a second preferred embodiment of the invention. FIGS. 8 and 8 both schematically illustrate with perspective views the translucent keycap 2 according to the second preferred embodiment of the invention. FIG. 10 is a cross sectional view of the translucent keycap 2 taken along the C-C line of FIG. 9. The translucent keycap 2 according to the second preferred embodiment is suitable to be assembled in a keyswitch of an illuminated keyboard.

As shown in FIGS. 8 to 10, similarly, the translucent keycap 2 according to the second preferred embodiment of the invention includes a translucent base 20, a first colored translucent layer 22, a light-shielding layer 24 and a second colored translucent layer 26. The translucent base 20 has an outer surface 202. The first colored translucent layer 22 overlays the outer surface 202 of the translucent base 20. The light-shielding layer 24 overlays the first colored translucent layer 22. The light-shielding layer 24 has a light-shielding region 242 and a first hollowed region 244. The first hollowed region 244 penetrates the light-shielding layer 24 such that a first portion of the first colored translucent layer 22 is exposed within the first hollowed region 244. The second colored translucent layer 26 is formed to cover the first hollowed region 244.

With different resulted structure in different coating way, as shown in FIGS. 8 to 10, a gap 249 exists between the second colored translucent layer 26 and an edge of the first hollowed region 244. In one case, an ink, not cured, of forming the second colored translucent layer 26 is coated on the first hollowed region 244, and a gap of about 0.03 mm exists between the region coated with the ink and the edge of the first hollowed region 244. During the curing of the ink, the ink flows outward due to its flowability, the ink is cured to form the second colored translucent layer 26 covering the first hollowed region 244, and the gap 249 between the second colored translucent layer 26 and the edge of the first hollowed region 244 is reduced to 0.01 mm. When the light OL passes through the translucent base 20, the first colored translucent layer 22, the first hollowed region 244 and the second colored translucent layer 26, the gap 249 is brighter than the second colored translucent layer 26. Thereby, the recognizability of the first hollowed region 244 representing the first pattern can be enhanced.

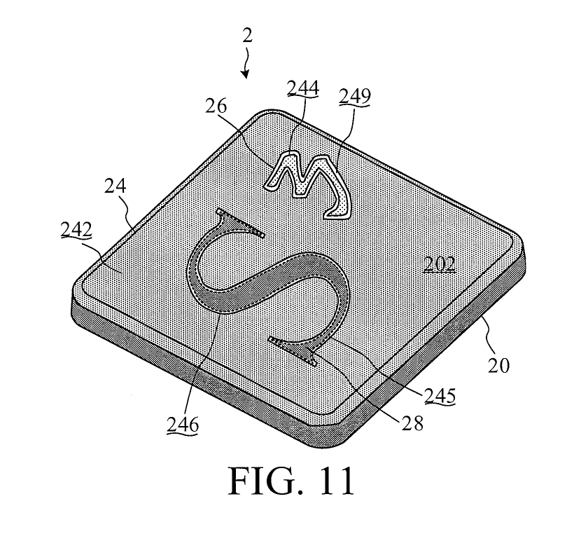

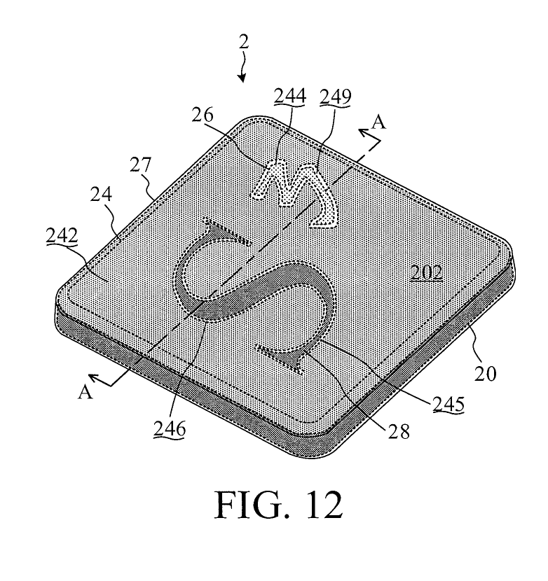

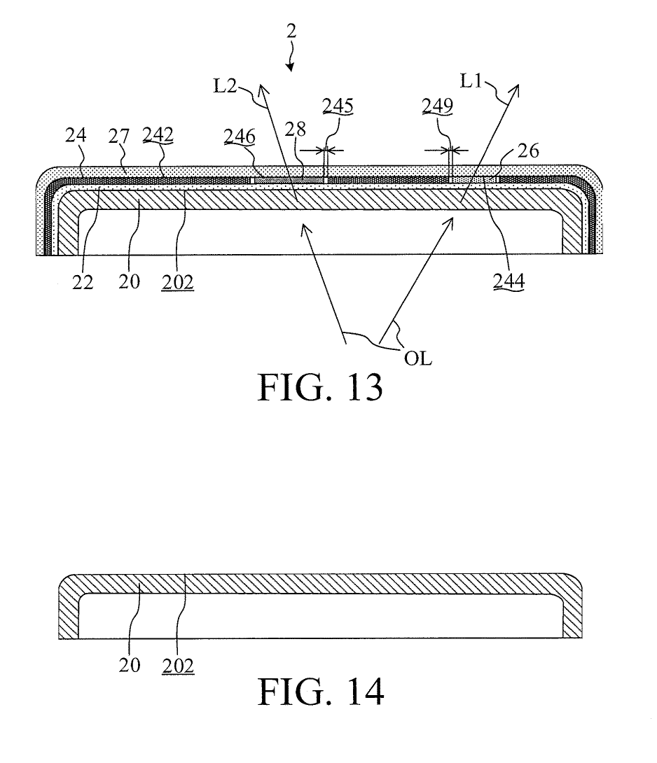

Referring to FIGS. 11 to 13, FIGS. 11 and 12 are respectively a cross sectional view of a modification of the translucent keycap 2 according to the second preferred embodiment of the invention. FIG. 13 is a cross sectional view of the translucent keycap 2 taken along the D-D line of FIG. 12. As shown in FIGS. 11 to 13, further, the translucent keycap 2 according to the second preferred embodiment of the invention also includes a third colored translucent layer 28. The third colored translucent layer 28 is formed to cover the second hollowed region 246. The third colored translucent layer 28 is different from the second colored translucent layer 26. The components and devices in FIGS. 11 to 13 identical to those shown in FIGS. 8 to 9 are given the same numerical notations, and will be not described in detail herein.

A gap 245 exists between the third colored translucent layer 28 and an edge of the second hollowed region 246. It is similar as the coating of the second colored translucent layer 26, an ink, not cured, of forming the third colored translucent layer 28 is coated on the second hollowed region 246, and a gap of about 0.03 mm exists between the region coated with the ink and the edge of the second hollowed region 246. During the curing of the ink, the ink flows outward due to its flowability, the ink is cured to form the third colored translucent layer 28 covering the second hollowed region 246, and the gap 245 between the third colored translucent layer 28 and the edge of the second hollowed region 246 is reduced to 0.01 mm. When the light OL passes through the translucent base 20, the first colored translucent layer 22, the second hollowed region 246 and the third colored translucent layer 28, the gap 245 is brighter than the third colored translucent layer 28. Thereby, the recognizability of the second hollowed region 246 representing the second pattern can be enhanced. The translucent keycap 2 shown in FIGS. 12 and 13 also includes a transparent protection layer 27. The transparent protection layer 27 is formed to overlay the light-shielding layer 24, the second colored translucent layer 26 and the third colored translucent layer 28.

Referring to FIGS. 14 through 21, those drawings with cross sectional views schematically illustrate the method according to the preferred embodiment of the invention to fabricate the translucent keycap 2 as shown in FIGS. 2, 3, 4, 7, 8, 9, 10 or 13.

Firstly, as shown in FIG. 14, the method of the invention is to prepare a translucent base 20 where the translucent base 20 has an outer surface 202.

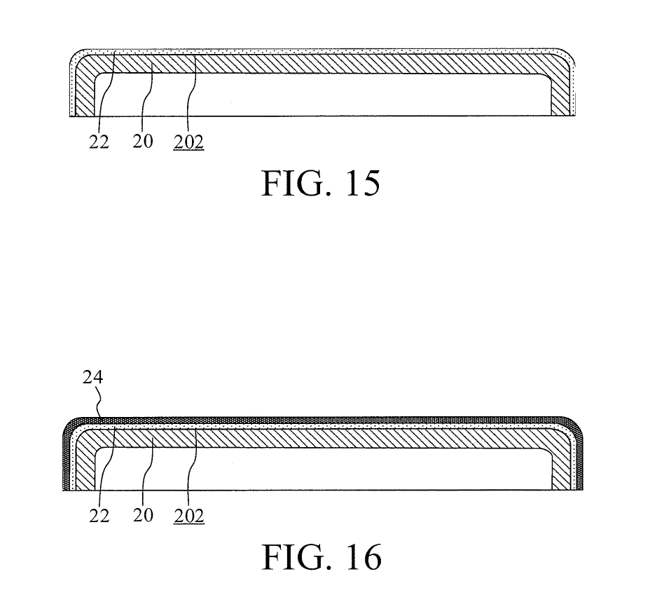

Next, as shown in FIG. 15, the method of the invention is to form a first colored translucent layer 22 to overlay the outer surface 202 of the translucent base 20. In one embodiment, the first colored translucent layer 22 can be, but not limited to, coated on the outer surface 202 of the translucent base 20 by a spraying process.

Then, as shown in FIG. 16, the method of the invention is to form a light-shielding layer 24 to overlay the first colored translucent layer 22. In one embodiment, light-shielding layer 24 can be, but not limited to, coated on the first colored translucent layer 22 by a spraying process.

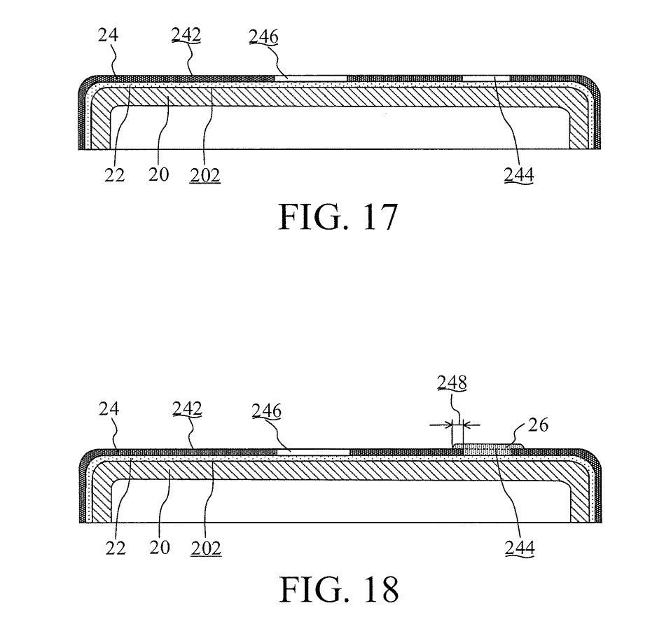

Subsequently, as shown in FIG. 17, the method of the invention is to form a first hollowed region 244 on the light-shielding layer 24 where the first hollowed region 244 penetrates the light-shielding layer 24 such that a first portion of the first colored translucent layer 22 is exposed within the first hollowed region 244. In one embodiment, the formation of the first hollowed region 244 can be, but not limited to, performed by a laser engraving process.

Referring to FIG. 17 again, further, the method of the invention is to form a second hollowed region 246 on the light-shielding layer 24 where the second hollowed region 246 penetrates the light-shielding layer 24 such that a second portion of the first colored translucent layer 22 is exposed within the second hollowed region 246. In one embodiment, the formation of the second hollowed region 246 can be, but not limited to, performed by a laser engraving process.

Finally, as shown in FIG. 18, the method of the invention is to form a second colored translucent layer 26 on the light-shielding layer 24 where the second colored translucent layer 26 covers the first hollowed region 244. In one embodiment, the second colored translucent layer 26 can be, but not limited to, coated on the first hollowed region 244 by a pad printing process or a screen printing process.

Also as shown in FIG. 18, in one embodiment, the light-shielding layer 24 also has a peripheral region 248 surrounding the first hollowed region 244. In the step of forming the second colored translucent layer 26, the second colored translucent layer 26 also extends onto the light-shielding layer 24 to cover the peripheral region 248 to finish the keycap 2 as shown in FIG. 2. That is to say that the horizontal size of the second colored translucent layer 26 is larger than that of the first hollowed region 244, and that the vertical height of the second colored translucent layer 26 is larger than that of the light-shielding layer 24.

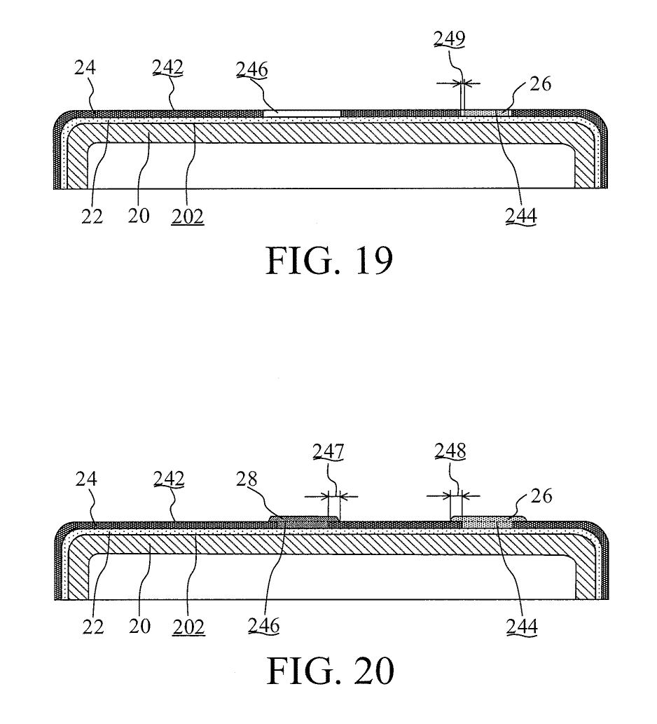

Alternatively, as shown in FIG. 19, a gap 249 exists between the second colored translucent layer 26 and an edge of the first hollowed region 244, and the resulted keycap 2 is similar as shown in FIG. 8.

In one embodiment, the first colored translucent layer 22 and the light-shielding layer 24 can be also coated on the translucent base 20 at the same time in an out-side mold decoration technology. The first colored translucent layer 22 and the light-shielding layer 24 are previously integrated into a covering film 3, as shown in FIG. 22. Next, the covering film 3 is covered on the outer surface 202 of the translucent base 20, where the covering film 3 includes, in sequence adjacent the outer surface 202 of the translucent base 20, the first colored translucent layer 22, the light-shielding layer 24, a release layer 32 and a base layer 30. Then, the covering film 3 is attached on the outer surface 202 of the translucent base 20. Finally, the base layer 30 and the release layer 32 are torn off to remain the first colored translucent layer 22 and the light-shielding layer 24 bonded on the outer surface 202 of the translucent base 20.

As for an embodiment with detailed description for the out-side mold decoration process, please refer to China Patent issued No. 104051170B, which describes how to place all of a plurality of translucent bases 20 of a plurality of keycaps, to be assembled in an entire keyboard, on a single fixture and then to place the fixture and the translucent bases together with a cover film 3 within a chamber. In the chamber, the cover film 3 is attached to the outer surfaces 202 of the translucent bases 20 by vacuumizing and/or pressurizing highly.

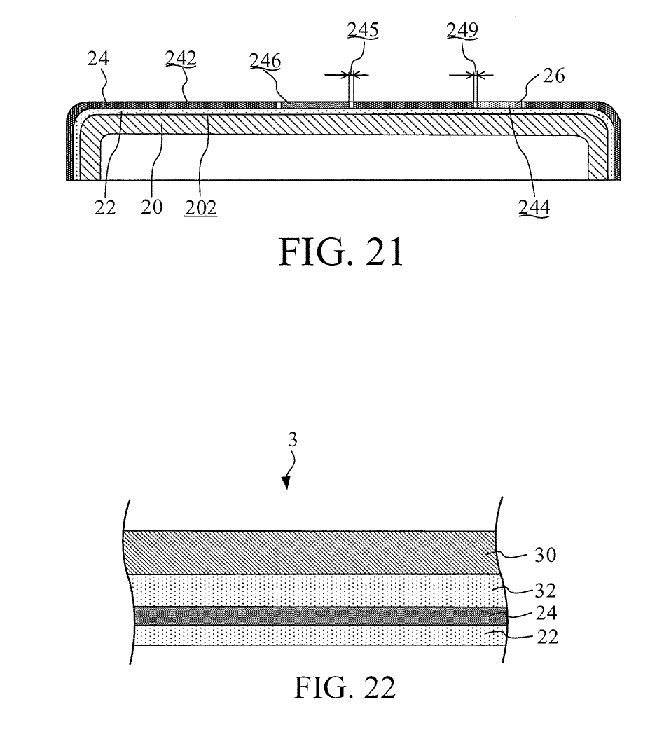

Furthermore, the method of the invention is to form a third colored translucent layer 28 to cover the second hollowed region 246. As shown in FIG. 20, similarly, the third colored translucent layer 28 completely covers the second hollowed region 246, also extends onto the peripheral region 247 to finish the translucent keycap 2 as shown in FIG. 5. Alternatively, as shown in FIG. 21, the third colored translucent layer 28 is formed, so that the gap 245 exists between the third colored translucent layer 28 and the edge of the second hollowed region 246, to finish the translucent keycap 2 as shown in FIG. 11.

After the translucent keycap 2 as shown in FIG. 18 is finished, further, the method of the invention is to form a transparent protection layer 27 to overlay the light-shielding layer 24, the second colored translucent layer 26 and the second hollowed region 246 to finish the translucent keycap 2 as shown in FIGS. 3 and 4. After the translucent keycap 2 as shown in FIG. 19 is finished, further, the method of the invention is to form a transparent protection layer 27 to overlay the light-shielding layer 24, the second colored translucent layer 26 and the second hollowed region 246 to finish the translucent keycap 2 as shown in FIGS. 9 and 10. After the translucent keycap 2 as shown in FIG. 20 is finished, further, the method of the invention is to form a transparent protection layer 27 to overlay the light-shielding layer 24, the second colored translucent layer 26 and the third colored translucent layer 28 to finish the translucent keycap 2 as shown in FIGS. 6 and 7. After the translucent keycap 2 as shown in FIG. 21 is finished, further, the method of the invention is to form a transparent protection layer 27 to overlay the light-shielding layer 24, the second colored translucent layer 26 and the third colored translucent layer 28 to finish the translucent keycap 2 as shown in FIGS. 12 and 13. The hardness of the transparent protection layer 27 is higher than that of the light-shielding layer 24 to prevent the light-shielding layer 24 from being abrading.

As for the manufacture of the translucent keycap 2 according to of the invention can previously prepare a large number of semi-finished products as shown in FIG. 17, and then produce finished products in accordance with luminous color specified by the customer's order. This way can dynamically adjust processes to change the color of the second colored translucent layer 26, even to change the color of the third colored translucent layer 28 in accordance with the customer's order.

With detailed description of the invention above, it is clear that the manufacturing process of the translucent keycaps according to the invention is relatively simple. Moreover, the manufacturing of the translucent keycaps according to the invention has flexibility and convenience.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A translucent keycap, comprising:
a translucent base, having an outer surface;
a first colored translucent layer, overlaying the outer surface of the translucent base;
a light-shielding layer, overlaying the first colored translucent layer, and having a light-shielding region and a hollowed region, the hollowed region penetrating the light-shielding layer such that a portion of the first colored translucent layer is exposed within the hollowed region; and
a second colored translucent layer, formed to cover the hollowed region;
wherein when a light travels upward from beneath the translucent keycap, the light is capable of passing through the translucent base, the first colored translucent layer, the hollowed region and the second colored translucent layer such that the hollowed region emits a color light;
wherein the light-shielding layer blocks the light from passing so that the hollowed region is brighter than the light-shielded region.

2. The translucent keycap of claim 1, wherein the light-shielding region comprises a peripheral region, the peripheral region surrounds the hollowed region, the second colored translucent layer also covers the peripheral region, when the light travels upward from beneath the translucent keycap, the hollowed region is brighter than the peripheral region.

3. The translucent keycap of claim 1, wherein a gap exists between the second colored translucent layer and an edge of the hollowed region.

4. A translucent keycap, comprising:
a translucent base, having an outer surface;
a first colored translucent layer, overlaying the outer surface of the translucent base, the first colored translucent layer comprising a first portion and a second portion;
a light-shielding layer, overlaying the first colored translucent layer, and having a light-shielding region, a first hollowed region and a second hollowed region, the first and the second hollowed regions penetrating the light-shielding layer such that the first and the second portions of the first colored translucent layer are exposed within the first and the second hollowed regions respectively; and
a second colored translucent layer, formed to cover the first hollowed region;
wherein when a light travels upward from beneath the translucent keycap, the light is capable of passing through the translucent base, the first colored translucent layer, the first hollowed region and the second colored translucent layer such that the first hollowed region emits a first color light;
wherein the light is also capable of passing through the translucent base, the first colored translucent layer and the second hollowed region such that the second hollowed region emits a second color light different from the first color light;
wherein the light-shielding layer blocks the light from passing so that the first and second hollowed regions are brighter than the light-shielded region.

5. The translucent keycap of claim 4, further comprising:
a transparent protection layer, overlaying the light-shielding layer, the second colored translucent layer and the second hollowed region, wherein a hardness of the transparent protection layer is higher than that of the light-shielding layer.

6. The translucent keycap of claim 4, wherein the light-shielding region comprises a peripheral region, the peripheral region surrounds the first hollowed region, the second colored translucent layer also covers the peripheral region, when the light travels upward from beneath the translucent keycap, the first hollowed region is brighter than the peripheral region.

7. The translucent keycap of claim 6, wherein an ambient light illuminates said translucent keycap from above, a reflectivity of the second colored translucent layer relative to the ambient light is low so that a visual difference between the peripheral region covered by the second colored translucent layer and the light-shielding region not covered by the second colored translucent layer is not recognizable.

8. The translucent keycap of claim 4, wherein a gap exists between the second colored translucent layer and an edge of the first hollowed region.

9. The translucent keycap of claim 4, further comprising:
a third colored translucent layer, being different from the second colored translucent layer and covering the second hollowed region, wherein the light is capable of passing through the translucent base, the first colored translucent layer, the second hollowed region and the third colored translucent layer such that the second hollowed region emits a third color light different from the first color light.

10. A method of fabricating a translucent keycap, comprising the steps of:
(a) preparing a translucent base having an outer surface;
(b) forming a first colored translucent layer to overlay the outer surface of the translucent base;
(c) forming a light-shielding layer to overlay the first colored translucent layer;
(d) forming a first hollowed region on the light-shielding layer, the first hollowed region penetrating the light-shielding layer such that a first portion of the first colored translucent layer is exposed within the first hollowed region; and
(e) forming a second colored translucent layer to cover the first hollowed region.

11. The method of claim 10, wherein the light-shielding layer also has a peripheral region surrounding the first hollowed region, and in step (e), the second colored translucent layer also extends onto the light-shielding layer and covers the peripheral region.

12. The method of claim 10, wherein a gap exists between the second colored translucent layer and an edge of the first hollowed region.

13. The method of claim 10, wherein step (b) and step (c) are performed by the steps of:
integrating the first colored translucent layer and the light-shielding layer into a covering film;
covering the covering film on the outer surface of the translucent base, wherein the covering film comprises, in sequence adjacent the outer surface of the translucent base, the first colored translucent layer, the light-shielding layer, a release layer and a base layer;
attaching the covering film on the outer surface of the translucent base; and
tearing off the base layer and the release layer to remain the first colored translucent layer and the light-shielding layer bonded on the outer surface of the translucent base.

14. The method of claim 13, further comprising the step of:
forming a second hollowed region on the light-shielding layer, the second hollowed region penetrating the light-shielding layer such that a second portion of the first colored translucent layer is exposed within the second hollowed region.

15. The method of claim 14, further comprising the step of:
forming a third colored translucent layer to cover the second hollowed region, the third colored translucent layer being different from the second colored translucent layer.

16. The method of claim 14, further comprising the step of:
forming a transparent protection layer to overlay the light-shielding layer, the second colored translucent layer and the second hollowed region, wherein a hardness of the transparent protection layer is higher than that of the light-shielding layer.
